(19) United States
(12) Patent Application Publication
(10) Pub. No.: US 2007/0005264 A1
(43) Pub. Date: Jan. 4, 2007

(54) System and method for chemical hazard classification

(76) Inventors: Karan Singh, Loveland, OH (US); Tom Jacques, Billings, MT (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/035,364

(22) Filed: Jan. 12, 2005

Related U.S. Application Data
(60) Provisional application No. 60/535,795, filed on Jan. 12, 2004.

(51) Int. Cl. G06F 19/00

(52) U.S. Cl. 702/22

(57) ABSTRACT

An exemplary method for the determination and classification of chemical hazards comprises the steps of: specifying physical data corresponding to a chemical material; optionally validating the physical data; and processing the physical data and/or validation data to produce a classification result. Various features and parameters of the present invention may be suitably adapted to optimize or otherwise improve the classification of chemical hazards. The present invention provides for improved response times to chemical spills as well as better management and control of information related to the characterization of hazards and the partitioning of chemical substances into various classification categories.

### RELATED APPLICATIONS

The present application claims priority from U.S. Provisional Patent Application Ser. No. 60/535,795, entitled “Chemical Categorization and Hazard Determination System and Method” filed Jan. 12, 2004, which is incorporated herein by reference.

### FIELD OF INVENTION

The present invention generally relates to hazard assessment and management technology; and more particularly, various exemplary and representative embodiments of the present invention permit the determination, categorization and communication of chemical hazards.

### BACKGROUND

In general, compliance with the Occupational Safety and Health Administration (hereafter, OSHA) Hazard Communication Standard may be difficult given conventional systems and/or tools. The Hazard Communication Standard promulgated in 1983 was designed inter alia to protect employees from exposure to hazardous chemicals. This standard generally assumes that employees have a right to know the hazards that they may be exposed to and that they will be able to protect themselves from in daily and/or emergency situations upon being made aware of potential hazards.

One mechanism employed to address the ‘right-to-know’ obligation has been Material Safety Data Sheets (hereafter, MSDS). In general, MSDS's have several inherent problems which include, for example, the following:

MSDS's are technically derived and usually difficult for their intended audience to read and interpret since most MSDS's are drafted by technical personnel for use by technical personnel;

Employees are generally unable to locate, understand or otherwise effectively use the information contained in MSDS's since they are frequently quite complicated, technically worded and available in a variety of different formats;

MSDS's generally do not provide an easy quantitative means for determining how hazardous a chemical may be;

There is typically no easy way to categorize certain chemicals or to determine their hazard level(s) using a substantially reproducible standard;

MSDS's may often be incomplete and/or inaccurate;

MSDS's may often be illegible;

Conventional MSDS's often contain redundant and/or conflicting information which may obscure, impede or otherwise interfere with a rapid and accurate assessment of a hazardous threat;

Foreign MSDS's that use the Metric System, other symbols and/or pictograms are not generally well understood by employees;

MSDS's which are overly verbose may overwhelm an employee, especially during an emergency;

Many organizations like colleges, hospitals and large corporations have thousands of chemicals for which it may be impossible to train employees concerning chemical hazards of all types that they may experience exposure to.

Training is another component of the Hazard Communication Standard. The challenge facing many companies, however, is that prior attempts have generally failed to provide a program that comprehensively addresses many of the hazards in the modest quantity of time typically provided for hazard communication training.

### SUMMARY OF THE INVENTION

In various representative aspects, the present invention provides a system and method for determining, characterizing, classifying, and communicating chemical hazard information. Representative features include the ability to specify state of matter data, toxicity data, corrosivity data, flammability data, reactivity data, and radioactivity data for a material. The data may be subsequent processed and validated to provide a classification value.

Advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF ASSOCIATED FIGURES

Representative elements, operational features, applications and/or advantages of the present invention reside in the details of construction and operation as more fully hereafter depicted, described and claimed—reference being made to the accompanying drawings forming a part hereof, wherein like numerals refer to like parts throughout. Other elements, operational features, applications and/or advantages may become apparent in light of certain exemplary embodiments recited in the Detailed Description, wherein:

FIG. 1 representatively illustrates a data flow diagram in accordance with a functional embodiment of the present invention;

FIG. 2 representatively illustrates a data flow diagram in accordance with a product-level embodiment of the present invention;

FIG. 3 representatively illustrates a screenshot in accordance with an exemplary embodiment of the present invention;

FIG. 4 representatively illustrates a screenshot in accordance with another exemplary embodiment of the present invention;

FIG. 5 representatively illustrates a screenshot in accordance with another

FIG. 6 representatively illustrates a screenshot in accordance with another exemplary embodiment of the present invention;

FIG. 7 representatively illustrates a screenshot in accordance with another exemplary embodiment of the present invention;

FIG. 8 representatively illustrates a screenshot in accordance with another exemplary embodiment of the present invention;

FIG. 9 representatively illustrates a screenshot in accordance with another exemplary embodiment of the present invention;

FIG. 10 representatively illustrates a database architecture in accordance with an exemplary embodiment of the present invention;

FIG. 11 representatively illustrates a partial view of a categorization flowchart in accordance with an exemplary embodiment of the present invention;

FIG. 12 representatively illustrates another partial view of a categorization flowchart in accordance with an exemplary embodiment of the present invention; and

FIG. 13 representatively illustrates a summary sheet generated in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are generally used for distinguishing between similar elements and not necessarily for describing a sequential or chronological order. Moreover, the terms “front”, “back”, “top”, “bottom”, “over”, “under”, and the like, if any, are generally employed for descriptive purposes and not necessarily for comprehensively describing exclusive relative position or order. Any of the preceding terms so used may be interchanged under appropriate circumstances such that various embodiments of the invention described herein, for example, are capable of operation in orientations and environments other than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements and/or method steps described in the disclosed exemplary embodiments without departing from the spirit and scope of the invention.

Various representative implementations of the present invention may be applied to any system for determining, categorizing and/or communicating chemical hazard information. Certain representative implementations may include, for example: training personnel, responding to a chemical spill, providing customized MSDS's, etc. As used herein, the terms “chemical”, “element”, “material”, “compound”, “article” and “matter”, or any variation or combination thereof, are generally intended to include anything that may be regarded as a tangible media (solid, liquid, gas, plasma, etc.) susceptible to characterization as having mass. The same shall properly be regarded as within the scope of the present invention.

A detailed description of an exemplary application, namely the parameterization, determination and classification of hazardous chemicals, is provided as a specific enabling disclosure that may be generalized to any application of the disclosed system and method for determining and/or categorizing any material. Moreover, it will be appreciated that the principles of the present invention may be employed to ascertain and/or realize any number of other benefits associated with determining or categorizing materials such as, but not limited to: threat assessment; inventory control; warehousing organization; industrial process control; and/or the like.

The disclosed system and method generally provides a systematic approach for converting data from difficult-to-use technical specifications to simple and easy-to-understand safe use guides. Various exemplary embodiments of the present invention employ a system and method to determine the hazard level of a chemical based on the properties of the chemical. The disclosed system also allows chemicals to be placed into one of, for example, about 57 substantially unique categories and approximately three hazard levels so that a chemical user (at work or home) may quickly identify the hazard level of a chemical and the proper precautions to take to avoid exposure, e.g. spills or other emergency incidents.

Various representative embodiments of the present invention also allow a chemical manufacturer or other user to quickly categorize a chemical by simply entering key properties of the chemical. The system then summarizes the hazards of the chemicals based on, for example, flammability, toxicity, corrosivity, and reactivity. The hazards may then be separated into primary, secondary and tertiary hazards to better warn employees.

Irrelevant information may be filtered out with the employees being provided with MSDS summary sheets that warns them of different physical and health hazards, how chemicals can enter their bodies, long and short-term effects of exposure, the proper personal protective equipment needed for protection, what procedures to follow in case of an incident, etc. The generated MSDS summary sheets are written in substantially simple English with short and direct sentences avoiding technical jargon. Foreign MSDS symbols are interpreted for a particular national audience.

Hazard warnings are generally categorized in RED, YELLOW and GREEN (e.g., HIGH, MEDIUM and LOW) based on the weight of relevant scientific evidence. For the color-blind, warning labels may have icons, numbers and/or letters, which may also indicate HIGH, MEDIUM and LOW hazard.

Each chemical categorized by the system may be given a Safe Use Guide to follow in case of an incident. Exemplary embodiments of the present invention generally reduce thousands of chemicals at a workplace to about 57 hazard categories, each with a Safe Use Guide. Training may be provided using groups of chemicals with similar characteristics, such as, for example, flammability, toxicity, etc. Training materials may be targeted to low-technical-experience audiences in which the members of this set generally do not possess basic language and math skills. Thereafter, employees may be tested for their comprehension and a record of employer initiated training may be maintained.

Additional advantages of various representative and exemplary embodiments of the present invention may also include, for example:

The provision of a reproducible, standard format for hazard information conveyed by MSDS's;

Allowing a layperson to identify the Hazard level and category of a chemical material based on information in the MSDS's;

Identifying any of the following: immediate level of danger; physical and health hazards; target organs, routes of entry into the body; correct personnel protective equipment; accurate labels for secondary containers; appropriate training by categories of chemicals; appropriate spill procedures and remediation products; chemical archive entries; etc.

Maximization of use of electronic access and transmission of MSDS's while ensuring reduced barriers to immediate access; and

Development of a site-specific and/or company-specific hazard communication plans.

In accordance with various representative and exemplary embodiments of the present invention, applicants herein disclose a computerized chemical hazard determination and categorization system/method. The disclosed system generally operates by selecting the physical state of a particular chemical and subsequently providing additional information concerning the characteristics of the selected physical state for a particular compound or material. Subsequently or concurrently, the categorization module may be suitably adapted to generate a coversheet for the selected chemical.

A system study addresses the functions of the present classification system for chemicals and generation of cover sheet for each classified chemical. It will be appreciated that information concerning the functional requirements of external systems may be readily available in the form of off-the-shelve modules or specifications conventionally available in the art. Accordingly, applicants here describe various interfacing components and elements associated with representative external systems.

In an representative application, the following variables may be used for providing an auto-categorization system in accordance with the present invention:

| | |
|---|---|
| S1, S2, S3, S4, S5, S6 | Physical State Codes |
| T1, T2, T3, T4, T5, T6, T7, T8 | Toxicity Codes |
| F0, F1, F2, F3, F4, F5 | Flammability Codes |
| R1, R2, R3 | General Reactivity Codes |
| A1, A2, A3 . . . | Specific Reactivity Codes |
| D1, D2, D3 . . . | Distinct Characteristic Codes |
| X1, X2, X3 | Radioactivity Codes |
| Z4, Z5, Z6, Z7, Z8, Z9, Z10, Z11, | Misc. Codes |
| Z12, Z13, Z14, Z15, Z16 | |

In a representative and exemplary embodiment, the codes presented vide supra may correspond to any of the following:

S1 Solid, Crystal, Powder

S2 Liquid

S3 Gas

S4 Solid/Liquid/Unidentified

S5 Cryogenic Gas/Aerosol

S6 Cryogenic Solid

T1 Extremely Toxic

T2 Toxic

T3 Slightly Toxic

T4 Biohazardous

T5 Cytotoxic

T6 Radioactive

T7 Hazardous Drug

T8 Pharmaceutical Drug

F1 Flammable

F2 Combustible

F3 May Combust

F4 Non-Combustible

R1 Extremely Reactive

R2 Reactive

R3 Slightly Reactive

A1 Organic Peroxide

A2 Unstable Peroxide

A3 Water Reactive

A4 Air Reactive

A5 Water and Air Reactive

A6 Oxidizer

A7 Explosive

A8 Water Reactive, Produces Toxic Gas

A9 Water Reactive, Produces Flammable Gas

A10 Water Reactive, Produces Toxic and Flammable Gas

D1 Polar

D2 Non-Polar

D3 Noxious

D4 Contamination Sensitive

D5 Friction Sensitive

D6 Irritant (Severe)

D7 Temperature Controlled

D8 Heat Sensitive

D9 Irritant (Slight to Moderate)

X1 Low Radioactivity

X2 Medium Radioactivity

X3 High Radioactivity

Z4 Mercury

Z5 Halogenated Solvents

Z6 Unidentified Substances

Z7 Oxygen

Z8 Phosphorus

Z9 Pharmaceutical Drugs

Z10 Articles

Z11 Carbon Dioxide

Z12 Mercury Thermometer

Z13 Alloys

Z14 Electrical Bulbs

Z15 Electrodes

Z16 Batteries

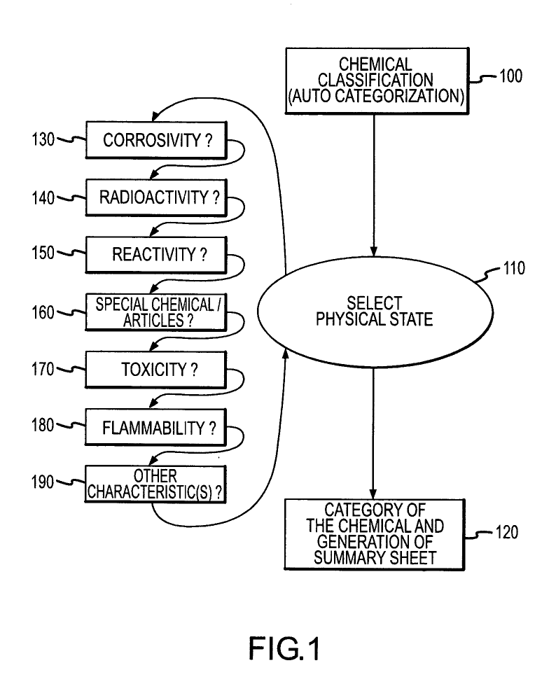

A data flow diagram (DFD), as generally provided in FIG. 1 for example, is a graphical technique that representatively depicts information flow in an exemplary embodiment of the present invention as well as the transforms that may be applied as data moves from at least one input to at least one output. The DFD schematic may also be termed a ‘data flow graph’ or a ‘bubble chart’.

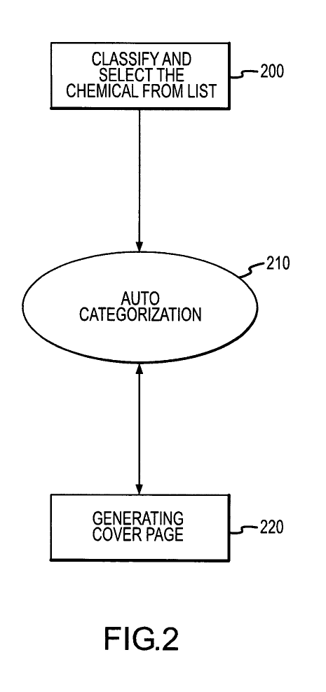

DFDs may be broken down into levels that represent increasing information flow and functional detail. A level 0 DFD is also called a context model, such as generally depicted in FIG. 2. This represents a system as a bubble with input and output data indicated by incoming and outgoing arrows. For example, a chemical material 200 may be generally provided to an auto-categorization routine 210 to produce a hazard summary sheet 220.

Level 1 DFDs generally contain more ‘bubbles’ with more complex connectivity, as generally depicted in FIG. 1. For example, a chemical material 100 may be generally subjected to categorization based on any of the following: state of matter data 110; corrosivity data 130; radioactivity data 140; reactivity data 150, chemical/article data 160; toxicity data 170; flammability data 180; and/or the like 190. The aggregate data may be optionally validated with respect to any other data value which may then be subsequently directed to produce a hazard summary sheet 120. Exemplary functions depicted in FIG. 1 may be considered representative sub-functions of the overall system generally depicted in the context model (i.e., FIG. 2).

In an exemplary embodiment of the present invention, the system may be divided into automatic components and manual components. Some of the processes may be automated, but most will generally be semi-automated and some may not be automated at all. Conventional methods generally employ highly qualified, technically trained professionals. The present invention provides a user-friendly interface for data entry that may be suitably adapted to at least partially categorize component data as information is entered into, for example, the MSDS fields. Some conventional systems may be semi-automated; however, the present invention provides a substantially fully automated solution that is both cost effective and fast.

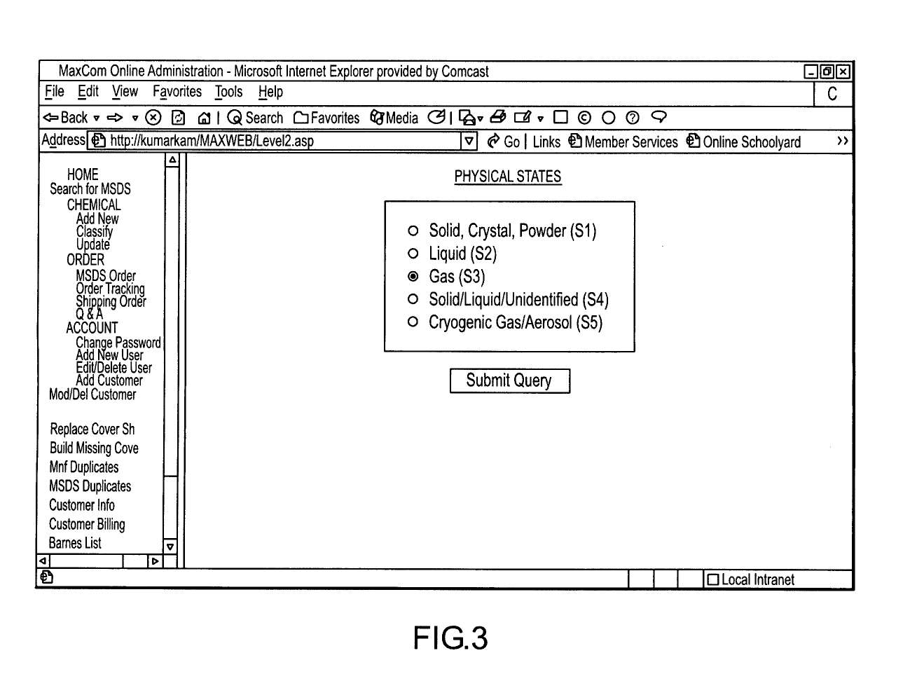

An exemplary system, in accordance with a representative embodiment of the present invention, may be engaged by accessing a classification link as generally depicted on the left on the screen illustrated immediately, for example, in FIG. 3. When the user, for example, clicks the ‘Classify’ line, a list of identification indices may be displayed with search criteria. The user may then select individual identification tags, for example, by clicking on an ID, or the user may select search criteria for subsequent categorization.

In one exemplary and representative embodiment, the initial screen for automated categorization may be suitably adapted to allow for the selection of physical state of matter as generally depicted, for example, in FIG. 3. As the user selects a chemical for subsequent categorization, a ‘physical states’ interface may be displayed in which the user may have five (5) selections to choose from: Solid, Crystal, Powder, etc. (S1); Liquid, etc. (S2); Gas, etc. (S3); Solid/Liquid/Unidentified, etc. (S4); and Cryogenic Gas/Aerosol, etc. (S5).

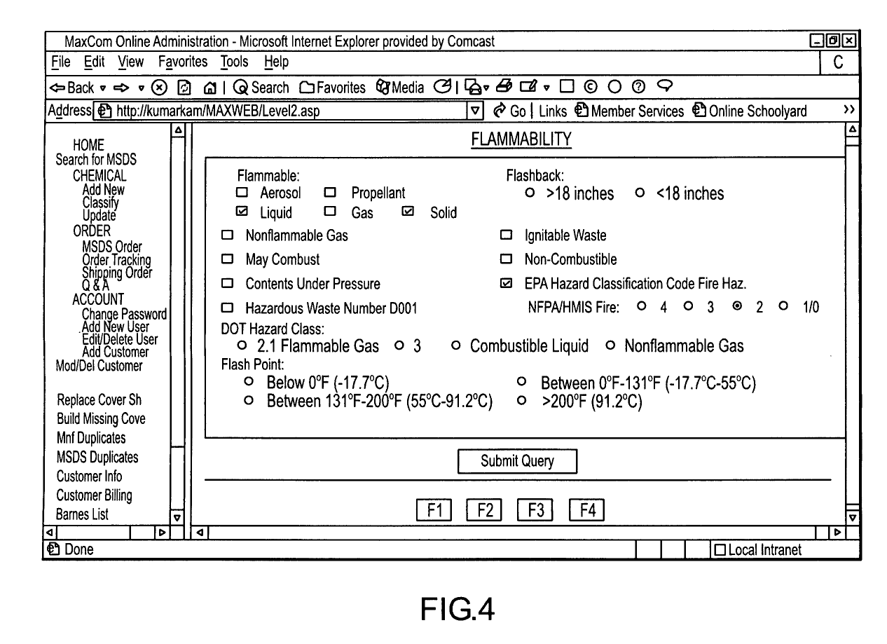

It will be appreciated that the caption “PHYSICAL STATES” may appear on the top or any other position of the window, as will also be the case for any screenshots discussed vide infra. Related information may be displayed in frames appearing, for example, underneath the label ‘Physical State’. The button “Submit Query” may appear under the frame. When this button or a functional equivalent is selected, the system will store the selected physical state data and proceed to the screen generally depicted in FIG. 4.

As generally illustrated in FIG. 4, the user may then be prompted to provide flammability data. Representative data elements corresponding to flammability may include any of the following: aerosol; propellant; liquid; gas; solid; flashback at greater than 18 inches; flashback at less than 18 inches; non-flammable gas; ignitable waste; possibility of combustion; non-combustibility; contents under pressure; EPA hazard classification code corresponding to fire hazard; hazardous waste; NFPA/HMIS fire designation; DOT hazard classification; flash point temperature; and/or the like.

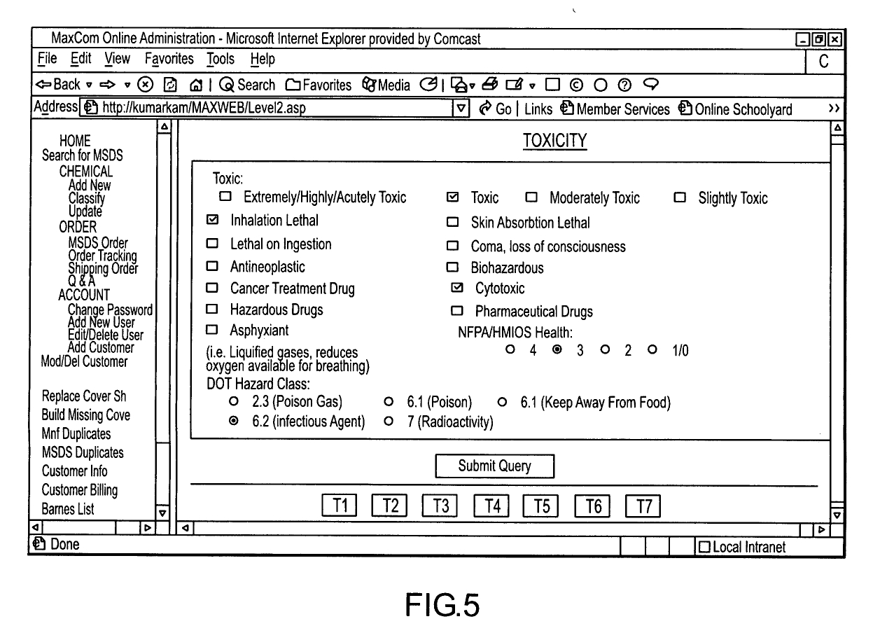

Related information may be displayed in frames appearing, for example, underneath the label ‘Flammability’. The button “Submit Query” may appear under the frame. When this button or a functional equivalent is selected, the system will store the selected flammability data and proceed to the screen generally depicted in FIG. 5. When the user makes this selection, there may be a combination of selected flammability criteria which may be subsequently correlated to specified flammability codes. These codes may be validated in terms of the selected physical state for the material. If the code combination selected is noted as ‘valid’, then a message box may appear and the selected combination may then be de-selected. If the selection is ‘valid’, then a specific code for flammability may also appear that provides access, for example, to the next screen and may be utilized during the generation of, for example, a summary sheet.

As generally illustrated in FIG. 5, the user may then be prompted to provide toxicity data. Representative data elements corresponding to toxicity may include any of the following: extremity of toxicity; inhalation lethality; skin absorption lethality; ingestion lethality; tendency to produce a coma or loss of consciousness; antineoplasticity; biohazard risk; cancer treatment; cytotoxicity; hazardous drug; pharmaceutical drug; asphyxiant; NFPA/HMIS health classification; DOT hazard classification; and/or the like.

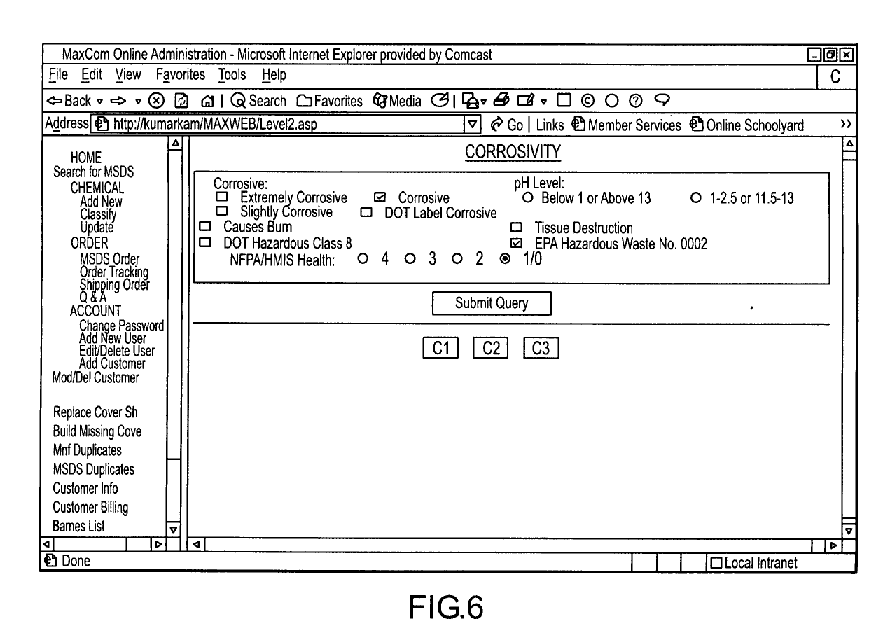

Related information may be displayed in frames appearing, for example, underneath the label ‘Toxicity’. The button “Submit Query” may appear under the frame. When this button or a functional equivalent is selected, the system will store the selected toxicity data and proceed to the screen generally depicted in FIG. 6. When the user makes this selection, there may be a combination of selected toxicity, flammability, and/or physical state criteria which may be subsequently correlated to specified toxicity codes. These codes may be validated in terms of the selected physical state and/or the flammability of the material. If the code combination selected is noted as ‘valid’, then a message box may appear and the selected combination may then be de-selected. If the selection is ‘valid’, then a specific code for toxicity may also appear that provides access, for example, to the next screen and may be utilized during the generation of, for example, a summary sheet.

As generally illustrated in FIG. 6, the user may then be prompted to provide corrosivity data. Representative data elements corresponding to corrosivity may include any of the following: strength of corrosivity; pH level; tendency to cause burns or destroy tissue; DOT hazard classification; EPA hazardous waste classification; NFPA/HMIS health classification; and/or the like.

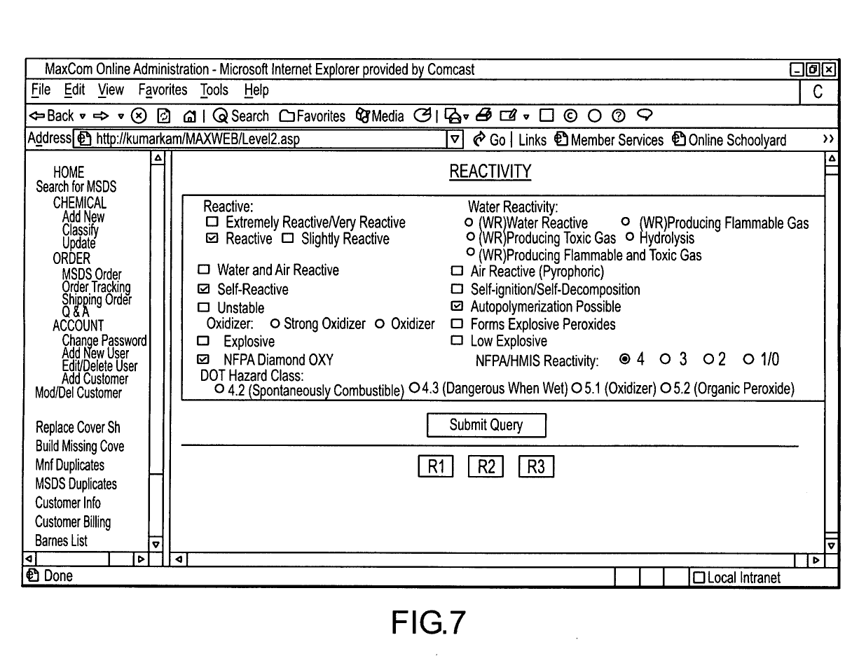

Related information may be displayed in frames appearing, for example, underneath the label ‘Corrosivity’. The button “Submit Query” may appear under the frame. When this button or a functional equivalent is selected, the system will store the selected corrosivity data and proceed to the screen generally depicted in FIG. 7. When the user makes this selection, there may be a combination of selected corrosivity, toxicity, flammability, and/or physical state criteria which may be subsequently correlated to specified corrosivity codes. These codes may be validated in terms of any of the selected physical state, the flammability, and the toxicity of the material. If the code combination selected is noted as ‘valid’, then a message box may appear and the selected combination may then be de-selected. If the selection is ‘valid’, then a specific code for corrosivity may also appear that provides access, for example, to the next screen and may be utilized during the generation of, for example, a summary sheet.

As generally illustrated in FIG. 7, the user may then be prompted to provide reactivity data. Representative data elements corresponding to reactivity may include any of the following: strength of reactivity; water reactivity index; water and air reactivity index; air reactive (pyrophoric) index; self-reactivity index; self-ignition/self-decomposition index; stability index; potential for auto-polymerization; oxidation index; tendency to form explosive peroxides; explosive strength index; NFPA Diamond OXY index; NFPA/HMIS reactivity classification; DOT hazard classification; and/or the like.

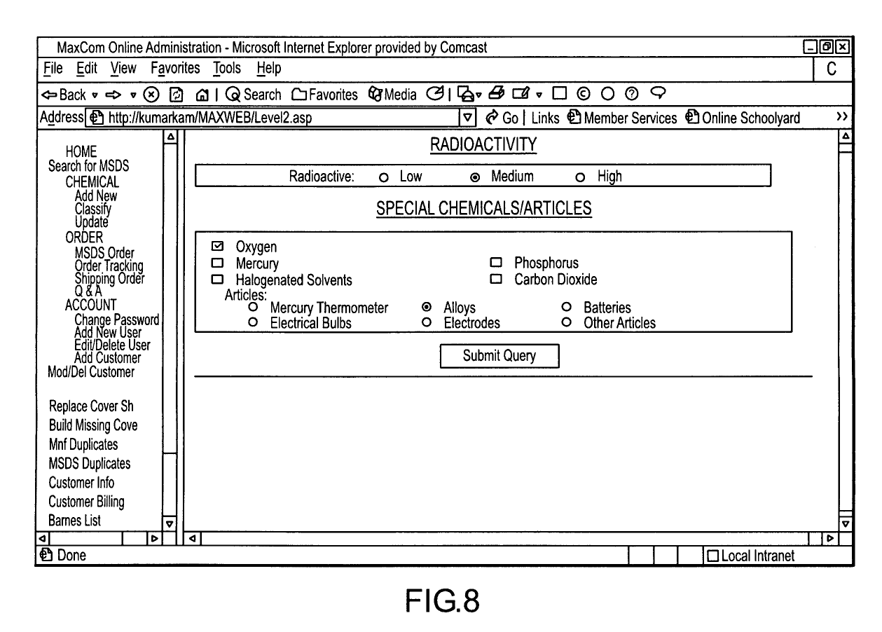

Related information may be displayed in frames appearing, for example, underneath the label ‘Reactivity. The button “Submit Query” may appear under the frame. When this button or a functional equivalent is selected, the system will store the selected reactivity data and proceed to the screen generally depicted in FIG. 8. When the user makes this selection, there may be a combination of selected reactivity, corrosivity, toxicity, flammability, and/or physical state criteria which may be subsequently correlated to specified reactivity codes. These codes may be validated in terms of any of the selected physical state, the flammability, the toxicity and corrosivity of the material. If the code combination selected is noted as ‘valid’, then a message box may appear and the selected combination may then be de-selected. If the selection is ‘valid’, then a specific code for reactivity may also appear that provides access, for example, to the next screen and may be utilized during the generation of, for example, a summary sheet.

As generally illustrated in FIG. 8, the user may then be prompted to provide radioactivity data. Representative data elements corresponding to radioactivity may include strength of radiative emissions and/or the like.

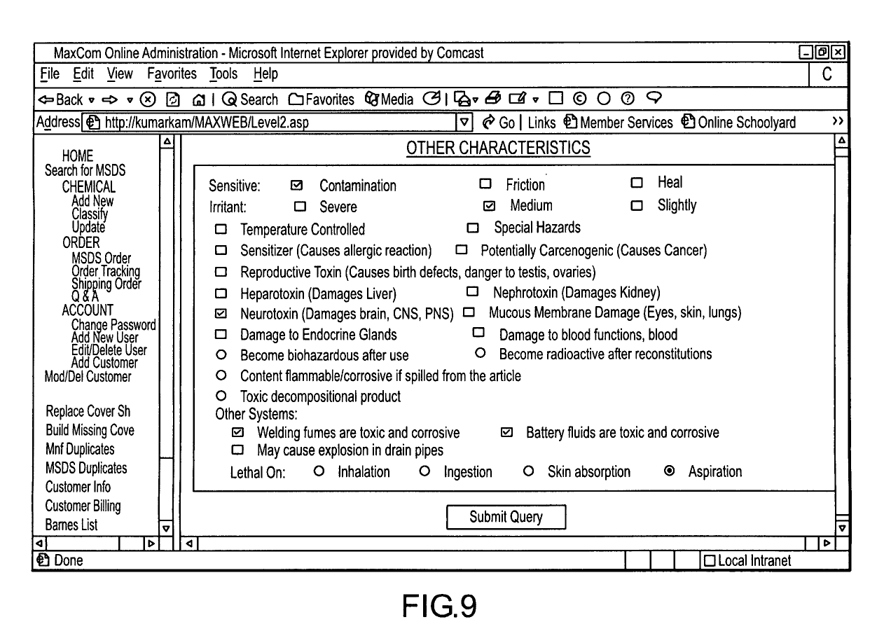

Related information may be displayed in frames appearing, for example, underneath the label ‘Radioactivity’. The button “Submit Query” may appear under the frame. When this button or a functional equivalent is selected, the system will store the selected reactivity data and proceed to the screen generally depicted in FIG. 9. When the user makes this selection, there may be a combination of selected radioactivity, reactivity, corrosivity, toxicity, flammability, and/or physical state criteria which may be subsequently correlated to specified radioactivity codes. These codes may be validated in terms of any of the selected physical state, the flammability, the toxicity, the corrosivity, and the reactivity of the material. If the code combination selected is noted as ‘valid’, then a message box may appear and the selected combination may then be de-selected. If the selection is ‘valid’, then a specific code for radioactivity may also appear that provides access, for example, to the next screen and may be utilized during the generation of, for example, a summary sheet.

As also generally illustrated in FIG. 8, the user may be prompted to provide special criteria data. Representative data elements corresponding to special criteria may include any of the following: oxygen; phosphorus; mercury; carbon dioxide; halogenated solvents; mercury thermometer; alloys; batteries; electrical bulbs; electrodes; and/or the like.

Related information may be displayed in frames appearing, for example, underneath the label ‘Special Chemicals/Articles’. The button “Submit Query” may appear under the frame. When this button or a functional equivalent is selected, the system will store the selected special criteria data and proceed to the screen generally depicted in FIG. 9. When the user makes this selection, there may be a combination of selected special criteria, radioactivity, reactivity, corrosivity, toxicity, flammability, and/or physical state criteria which may be subsequently correlated to specified special criteria codes. These codes may be validated in terms of any of the selected physical state, the flammability, the toxicity, the corrosivity, the reactivity, and the radioactivity of the material. If the code combination selected is noted as ‘valid’, then a message box may appear and the selected combination may then be de-selected. If the selection is ‘valid’, then a specific code for special criteria may also appear that provides access, for example, to the next screen and may be utilized during the generation of, for example, a summary sheet.

As generally illustrated in FIG. 9, the user may be prompted to provide miscellaneous data. Representative data elements corresponding to miscellaneous criteria may include any of the following: sensitivity to contamination; sensitivity to friction; sensitivity to heat; tendency and strength of irritation; temperature controlled; special hazard; allergenic sensitivity; carcinogenic; reproductive toxicity; heparotoxicity; nephrotoxicity; neurotoxicity; tendency to produce mucous membrane damage; tendency to damage endocrine glands; tendency to damage blood function; tendency to become biohazardous after use; tendency to become radioactive after reconstitution; flammable/corrosive if spilled from article; tendency to produce toxic decomposition products; welding fumes; battery fluids; drainage pipe hazards; lethality upon inhalation, ingestion, skin absorption, aspiration; and/or the like.

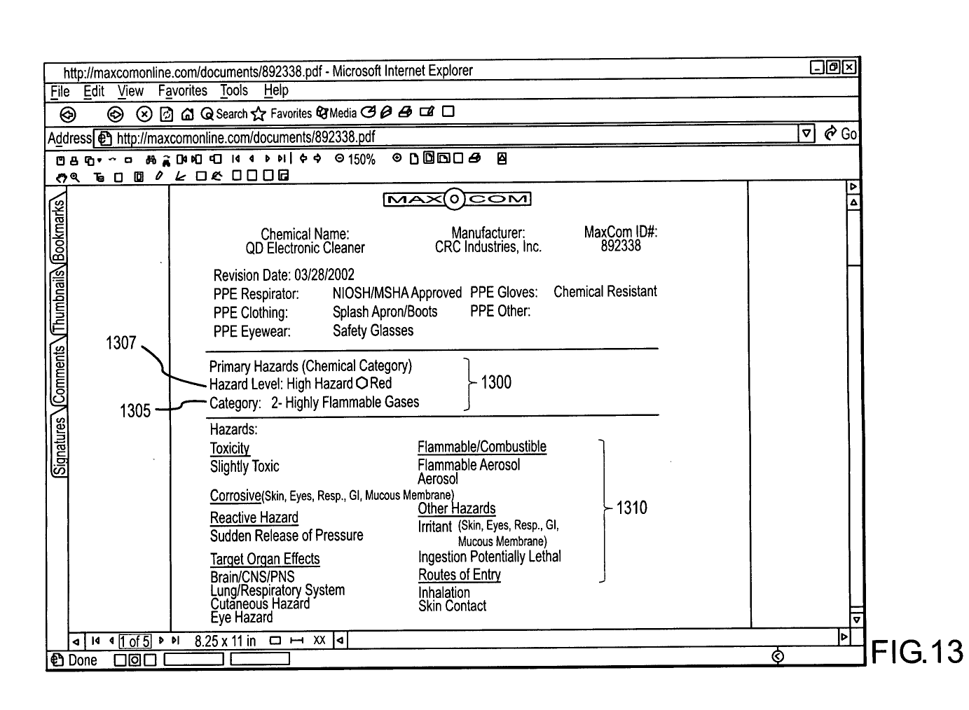

Related information may be displayed in frames appearing, for example, underneath the label ‘Other Characteristics’. The button “Submit Query” may appear under the frame. When this button or a functional equivalent is selected, the system will store the selected miscellaneous criteria data and proceed to generate the summary sheet, for example generally depicted in FIG. 13. When the user makes this selection, there may be a combination of selected miscellaneous criteria, special criteria, radioactivity, reactivity, corrosivity, toxicity, flammability, and/or physical state criteria which may be subsequently correlated to specified miscellaneous criteria codes. These codes may be validated in terms of any of the selected physical state, the flammability, the toxicity, the corrosivity, the reactivity, and the radioactivity of the material. If the code combination selected is noted as ‘valid’, then a message box may appear and the selected combination may then be de-selected. If the selection is ‘valid’, then a specific code for miscellaneous criteria may also appear that provides access, for example, to the next screen and may be utilized during the generation of, for example, a summary sheet.

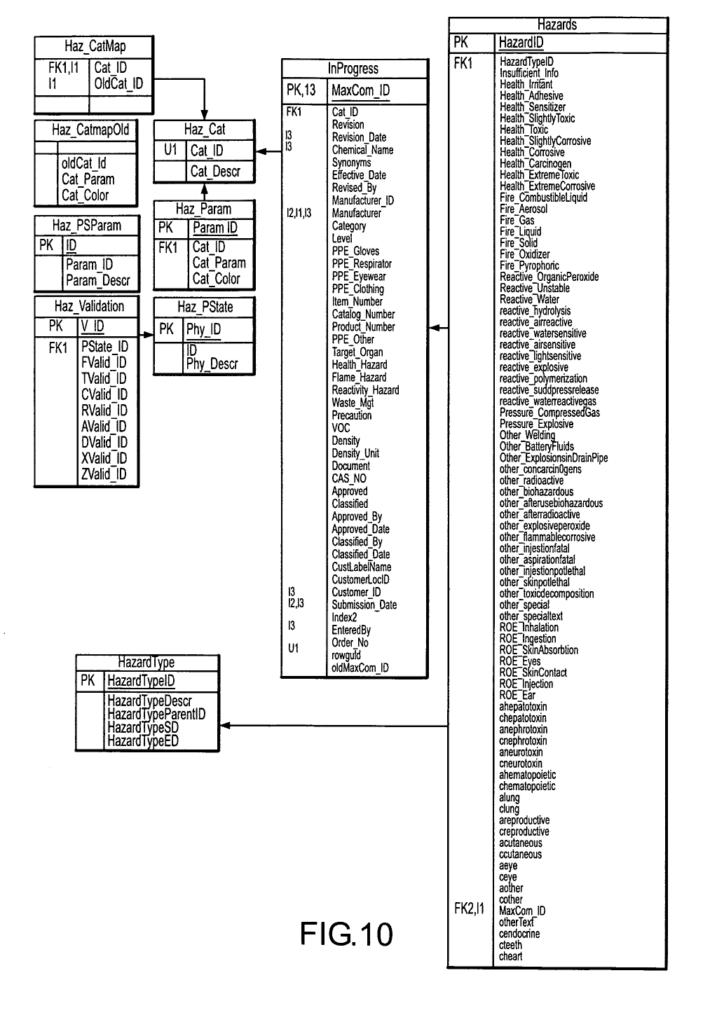

In accordance with various representative and exemplary embodiments of the present invention, a database structure similar to that depicted, for example, in FIG. 10 may be used in accordance with the following:

| TABLE: | Haz_cat | Table: | haz_catmap |
|---|---|---|---|
| Cat_ID | CAT_Description | Cat_Id | OldCat_Id |
| 1 | Gases Highly Flammable | 1 | 2 |
| | (compressed, Liquefied or | | |
| | Cryogenic) | | |
| 2 | Gases- Flammable and/or Toxic | 2 | 3 |
| | (compressed, Liquefied or | | |
| | Cryogenic) | | |
| 3 | Gases- Slightly Toxic, | 3 | 5 |
| | Corrosive, and Combustible | | |
| | (compressed, Liquefied or | | |
| | Cryogenic) | | |
| 4 | Gases- Toxic and/or Corrosive | 4 | 6 |
| | (compressed, Liquefied or | | |
| | Cryogenic) | | |
| 5 | Gases- Non-reactive Asphyxiants | 5 | 9 |
| | (compressed, Liquefied or | | |
| | Cryogenic) | | |
| 6 | Carbon dioxide (compressed, | 6 | 9 |
| | Liquefied or Solid) | | |
| 7 | Gases- Oxidizing (compressed, | 7 | 16 |
| | Liquefied or Cryogenic) | | |
| 8 | Oxygen (compressed, Liquefied | 8 | 26 |
| | or Cryogenic) | | |
| 9 | Gases- Toxic, Corrosive, and | 9 | 12 |
| | Oxidizing (compressed, | | |
| | Liquefied or Cryogenic) | | |
| 10 | Gases- Toxic, Spontaneously | 10 | 15 |
| | Combustible(Pyrophoric) | | |
| | (compressed or Liquefied) | | |
| 11 | Gases- Flammable (Unstable) | 11 | 2 |
| 12 | Gases- Flammable, Corrosive | 12 | 3 |
| 13 | Gases- Corrosive | 13 | 6 |
| 14 | Liquids- Highly Flammable | 14 | 1 |
| 15 | Liquids- Flammable | 15 | 1 |
| 16 | Liquids- Highly Flammable, | 16 | 19 |
| | Toxic | | |
| 17 | Liquids- Flammable, Toxic | 17 | 19 |
| 18 | Liquids- Highly Flammable, | 18 | 20 |
| | Toxic and/or Corrosive | | |
| 19 | Liquids- Flammable, Toxic | 19 | 20 |
| | and/or Corrosive | | |
| 20 | Liquids-Flammable, Corrosive | 20 | 20 |
| 21 | Solids- Flammable | 21 | 13 |
| 22 | Solids- Flammable, Toxic | 22 | 13 |
| | and/or Corrosive | | |
| 23 | Substances- Self-reactive | 23 | 22 |
| 24 | Substances- Self-reactive, | 30 | 11 |
| | Temperature Controlled | | |
| 25 | Substances- Spontaneously | 31 | 27 |
| | Combustible (Air-reactive) | | |
| 26 | Substances- Spontaneously | 33 | 28 |
| | Combustible (Air and/or | | |
| | Water-reactive) | | |
| 27 | Substances- Water-reactive | 34 | 31 |
| | (Evolving Flammable Gases) | | |
| 28 | Substances- Water-reactive | 35 | 13 |
| | (Evolving Flammable/Toxic | | |
| | Gases) | | |
| 29 | Substances- Water-reactive | 35 | 30 |
| | Oxidizers(Evolving Toxic | | |
| | and/or Corrosive Substances) | | |
| 30 | Substances- Toxic | 36 | 23 |
| 31 | Substances - Toxic and | 36 | 31 |
| | Combustible | | |
| 32 | Substances- Combustible, | 37 | 28 |
| | Toxic and/or Corrosive | | |
| 33 | Substances- Toxic and/or | 39 | 4 |
| | Corrosive (Non-Combustible) | | |
| 34 | Substances- Flammable, Toxic | 39 | 18 |
| | and/or Corrosive (Water- | | |
| | reactive) | | |
| 35 | Substances-Combustible, Toxic | 39 | 22 |
| | and or Corrosive (Water- | | |
| | reactive) | | |
| 36 | Substances-Non-Combustible, | 39 | 24 |
| | Corrosive and/or Toxic | | |
| | (Water-reactive) | | |
| 37 | Substances- Water-reactive and | 40 | 4 |
| | Corrosive | | |
| 38 | Phosphorus, White or Yellow | 41 | 8 |
| 39 | Oxidizers | 41 | 17 |
| 40 | Oxidizers- Toxic | 41 | 25 |
| 41 | Organic Peroxides | 42 | 10 |
| 42 | Substances- Irritating | 43 | 11 |
| 43 | Halogenated Solvents | 44 | 11 |
| 44 | Mercury | 45 | 10 |
| 45 | Low to Moderate Hazard | 51 | 10 |
| | Substances | | |
| 46 | Mercury Thermometers | 52 | 11 |
| 47 | Alloys | 53 | 35 |
| 48 | Electrical Bulbs | 54 | 33 |
| 49 | Electrodes | 55 | 34 |
| 50 | Batteries | 56 | 32 |
| 51 | Articles | | |
| 52 | Pharmaceutical Drugs | | |
| 53 | Hazardous Drugs | | |
| 54 | Cytotoxic Drugs | | |
| 55 | Radioactive Substances | | |
| 56 | Biohazardous Substances | | |
| 57 | Explosives | | |

| TABLE: | haz_catmapoid | | | Table: | haz_psparam |
|---|---|---|---|---|---|
| Oldcat_id | Cat_param | Cat_color | Id | Param_id | Param_descr |
| 1 | S2, F1 | Red | 1 | T1 | Extremely/Highly Toxic |
| 2 | S5, F1 | Red | 2 | T2 | Toxic |
| 3 | S5, F1, T1 | Red | 3 | T3 | Slightly Toxic |
| 3 | S5, F2, T2 | Yellow | 4 | T4 | Biohazardous |
| 4 | S4, R1, A6 | Red | 5 | T5 | Cytotoxic |
| 4 | S4, R2, A6 | Yellow | 6 | T6 | Asphyxiant |
| 5 | S5, F2, T3, C2 | Yellow | 7 | C1 | Extremely Corrosive |
| 6 | S5, T1, C1 | Red | 8 | C2 | Corrosive |
| 6 | S5, T2, C2 | Yellow | 9 | C3 | Slightly Corrosive |
| 7 | S6 | Yellow | 10 | F0 | Highly Flammable |
| 8 | S4, R1, A1 | Red | 11 | F0 | Highly Flammable |
| 8 | S4, R2, A1 | Yellow | 12 | F1 | Flammable |
| 9 | S5, F4 | Yellow | 13 | F2 | Combustible |
| 9 | S5, F4 | Yellow | 14 | F3 | May Combust |
| 10 | NULL | NULL | 15 | F4 | Non-Combustible |
| 10 | NULL | NULL | 16 | F5 | Spontaneously Combustible |
| 11 | S4, T1 | Red | 17 | R1 | Extremely Reactive |
| 11 | S4, T2 | Yellow | 18 | R2 | Reactive |
| 12 | S5, T1, C1, A6 | Red | 19 | R3 | Slightly Reactive |
| 13 | S1, F1 | Red | 20 | A1 | Organic Peroxide |
| 13 | S1, F2 | Yellow | 21 | A2 | Unstable Reactive |
| 14 | S4, R1, A7 | Red | 22 | A3 | Water Reactive |
| 15 | S5, T1, R7, A4 | Red | 23 | A4 | Air Reactive |
| 16 | S5, R1, A6 | Red | 24 | A5 | Air and Water Reactive |
| 16 | S5, R2, A6 | Red | 25 | A6 | Oxidizer |
| 17 | S4, R1, A4 | Red | 26 | A7 | High Explosive |
| 17 | S4, R2, A4 | Yellow | 27 | A8 | Water Reactive producing Toxic Gas |
| 18 | S4, R1, A3, A9 | Red | 28 | A9 | Water Reactive producing Flammable Gas |
| 18 | S4, R2, A3, A9 | Yellow | 29 | A10 | Water Reactive producing Flammable and Toxic Gas |
| 19 | S2, F1, T1 | Red | 30 | A11 | Self-reactive/Self-ignition/Self Decomposition |
| 19 | S2, F1, T2 | Yellow | 31 | A12 | Low Explosive |
| 20 | S2, F1, T1, C1 | Red | 32 | A13 | Desensitized Explosive |
| 20 | S2, F1, T2, C1 | Red | 33 | A14 | Water Reactive producing Toxic and Corrosive |
| | | | | | Substances |
| 20 | S2, F1, T1, C2 | Red | 37 | D4 | Contamination Sensitive |
| 20 | S2, F1, T2, C2 | Yellow | 38 | D5 | Friction Sensitive |
| 21 | S4, F2, T1 | Red | 39 | D6 | Irritant (Severe) |
| 21 | S4, F2, T2 | Yellow | 40 | D7 | Temperature Controlled |
| 22 | S4, R1, A2 | Red | 41 | D8 | Heat Sensitive |
| 23 | S4, R1, A3 | Red | 42 | D9 | Irritant(slight to moderate) |
| 23 | S4, R1, A4 | Red | 43 | X1 | Low |
| 23 | S4, R2, A3 | Yellow | 44 | X2 | Medium |
| 23 | S4, R2, A4 | Yellow | 45 | X3 | High |
| 24 | S4, R1, A10 | Red | 46 | Z4 | Mercury |
| 25 | S4, R1, A3, A6, A8 | Red | 47 | Z5 | Halogenated Solvents |
| 25 | S4, R2, A3, A6, A8 | Yellow | 49 | Z7 | Oxygen |
| 26 | S5, OX | Yellow | 50 | Z8 | Phosphorus |
| 27 | S4, F2, T1, C1 | Red | 51 | Z9 | Pharmaceutical Drugs |
| 27 | S4, F2, T1 | Red | 52 | Z10 | Articles |
| 27 | S4, F2, C1 | Red | 53 | T7 | Hazardous Drugs |
| 27 | S4, F2, T2, C2 | Yellow | 54 | T8 | Pharmaceutical Drugs |
| 27 | S4, F2, T2 | Yellow | 55 | Z11 | Carbon dioxide |
| 27 | S4, F2, C2 | Yellow | 56 | Z12 | Mercury Thermometer/Article |
| 28 | S4, F4, T1, C1 | Red | 57 | Z13 | Alloys |
| 28 | S4, F4, T1 | Red | 58 | Z14 | Electrical Bulbs |
| 28 | S4, F4, C1 | Red | 59 | Z15 | Electrodes |
| 28 | S4, F4, T2, C2 | Yellow | 60 | Z16 | Batteries |
| 28 | S4, F4, T2 | Yellow | | | |
| 28 | S4, F4, C2 | Yellow | | | |
| 29 | S4, F1, T1, C1, A3 | Red | | | |
| 29 | S4, F1, T1, A3 | Red | | | |
| 29 | S4, F1, C1, A3 | Red | | | |
| 29 | S4, F1, T2, A3 | Yellow | | | |
| 29 | S4, F1, C2, A3 | Yellow | | | |
| 30 | S4, F2, T2, C2, A3 | Yellow | | | |
| 30 | S4, F2, T2, A3 | Yellow | | | |
| 30 | S4, F2, C2, A3 | Yellow | | | |
| 30 | S4, F2, T1, C1, A3 | Red | | | |
| 30 | S4, F2, T1, A3 | Red | | | |
| 30 | S4, F2, C1, A3 | Red | | | |
| 31 | S4, F4, T1, C1, A3 | Red | | | |
| 31 | S4, F4, C1, A3 | Red | | | |
| 31 | S4, F4, T1, A3 | Red | | | |
| 31 | S4, F4, T2, C2, A3 | Yellow | | | |
| 31 | S4, F4, C2, A3 | Yellow | | | |
| 31 | S4, F4, T2, A3 | Yellow | | | |
| 32 | T4 | Yellow | | | |
| 33 | T5 | Red | | | |
| 34 | T6 | Red | | | |
| 35 | T7 | Red | | | |
| 36 | S4, T1, T8 | Red | | | |
| 36 | S4, T2, T8 | Red | | | |
| 36 | S4, T3, T8 | Yellow | | | |

| | TABLE: | Haz_param | |
|---|---|---|---|
| 1 | 1 | S5, F0 | Red |
| 2 | 2 | S5, F1, T1 | Red |
| 3 | 2 | S5, F1, T2 | Red |
| 4 | 3 | S5, F2, T3, C1 | Red |
| 5 | 3 | S5, F2, T3, C2 | Yellow |
| 6 | 4 | S5, T1, C1 | Red |
| 7 | 4 | S5, T1, C2 | Red |
| 8 | 4 | S5, T2, C1 | Red |
| 9 | 4 | S5, T2, C2 | Yellow |
| 10 | 5 | S5, F4, T7 | Yellow |
| 11 | 6 | S4, F4, T7, Z11 | Yellow |
| 12 | 6 | S6, F4, T7, Z11 | Yellow |
| 13 | 7 | S5, A4 | Yellow |
| 14 | 8 | S5, Z7 | Yellow |
| 15 | 9 | S5, T1, C1, A6 | Red |
| 16 | 9 | S5, T1, C2, A6 | Red |
| 17 | 9 | S5, T2, C1, A6 | Red |
| 18 | 9 | S5, T2, C2, A6 | Yellow |
| 19 | 10 | S5, F5, T1 | Red |
| 20 | 10 | S5, F5, T2 | Red |
| 21 | 11 | S5, F1, A2 | Red |
| 22 | 11 | S5, F0, A2 | Red |
| 23 | 12 | S5, F1, C1 | Red |
| 24 | 12 | S5, F1, C2 | Red |
| 25 | 12 | S5, F2, C1 | Red |
| 26 | 12 | S3, F1, C1 | Red |
| 27 | 12 | S3, F1, C2 | Red |
| 28 | 12 | S3, F2, C1 | Red |
| 29 | 12 | S5, F2, C2 | Yellow |
| 30 | 12 | S3, F2, C2 | Yellow |
| 31 | 13 | S3, C1 | Red |
| 32 | 13 | S3, C2 | Yellow |
| 33 | 14 | S2, F0 | Red |
| 34 | 15 | S2, F1 | Red |
| 35 | 16 | S2, F0, T1 | Red |
| 36 | 16 | S2, F0, T2 | Red |
| 37 | 17 | S2, F1, T1 | Red |
| 38 | 17 | S2, F1, T2 | Red |
| 39 | 18 | S2, F0, T1, C1 | Red |
| 40 | 18 | S2, F0, T2, C1 | Red |
| 41 | 18 | S2, F0, T1, C2 | Red |
| 42 | 19 | S2, F1, T1, C1 | Red |
| 43 | 19 | S2, F1, T2, C1 | Red |
| 44 | 19 | S2, F1, T1, C2 | Red |
| 45 | 20 | S2, F1, C1 | Red |
| 46 | 20 | S2, F2, C1 | Red |
| 47 | 20 | S2, F1, C2 | Red |
| 48 | 20 | S2, F2, C2 | Yellow |
| 49 | 21 | S1, F1 | Red |
| 50 | 22 | S1, F1, T1, C1 | Red |
| 51 | 22 | S1, F2, T1, C1 | Red |
| 52 | 22 | S1, F1, T2, C1 | Red |
| 53 | 22 | S1, F2, T2, C1 | Red |
| 54 | 22 | S1, F1, T1, C2 | Red |
| 55 | 22 | S1, F2, T2, C2 | Yellow |
| 56 | 23 | S4, F1 | Red |
| 57 | 24 | S4, A11, D7 | Red |
| 58 | 25 | S4, F5, A4 | Red |
| 59 | 26 | S4, F5, A3, A4 | Red |
| 60 | 27 | S4, R1, A9 | Red |
| 61 | 27 | S4, R2, A9 | Yellow |
| 62 | 28 | S4, R1, A10 | Red |
| 63 | 28 | S4, R2, A10 | Yellow |
| 64 | 29 | S4, R1, A6, A14 | Red |
| 65 | 29 | S4, R2, A6, A14 | Yellow |
| 66 | 30 | S4, T1 | Red |
| 67 | 30 | S4, T2 | Yellow |
| 68 | 31 | NULL | NULL |
| 69 | 32 | S4, F2, T1, C1 | Red |
| 70 | 32 | S4, F2, T1, C2 | Red |
| 71 | 32 | S4, F2, T2, C1 | Red |
| 72 | 32 | S4, F2, T2, C2 | Red |
| 73 | 33 | S4, T1, C1 | Red |
| 74 | 33 | S4, T2, C1 | Red |
| 75 | 33 | S4, T1, C2 | Red |
| 76 | 33 | S4, T2, C2 | Red |
| 77 | 34 | S4, F1, T1, C1, A3 | Red |
| 78 | 34 | S4, F1, T1, C2, A3 | Red |
| 79 | 34 | S4, F1, T2, C1, A3 | Red |
| 80 | 35 | S4, F2, T1, C1, A3 | Red |
| 81 | 35 | S4, F2, T2, C2, A3 | Red |
| 82 | 35 | S4, F2, T1, C2, A3 | Red |
| 83 | 35 | S4, F2, T2, C2, A3 | Yellow |
| 84 | 36 | S4, T1, C1, A3 | Red |
| 85 | 36 | S4, T2, C1, A3 | Red |
| 86 | 36 | S4, T1, C2, A3 | Red |
| 87 | 36 | S4, T2, C2, A3 | Yellow |
| 88 | 37 | S4, C1, A3 | Red |
| 89 | 37 | S4, C2, A3 | Yellow |
| 90 | 38 | S1, F1, Z8 | Red |
| 91 | 39 | S4, R1, A6 | Red |
| 92 | 39 | S4, R2, A6 | Yellow |
| 93 | 39 | S4, R1, A6, D4, D8 | Red |
| 94 | 39 | S4, R2, A6, D4, D8 | Yellow |
| 95 | 39 | S4, R1, A6, D4, D5, D8 | Red |
| 96 | 39 | S4, R2, A6, D4, D5, D8 | Yellow |
| 97 | 40 | S1, T1, A6 | Red |
| 98 | 40 | S1, T2, A6 | Yellow |
| 99 | 40 | S2, T1, A6 | Red |
| 100 | 40 | S2, T2, A6 | Yellow |
| 101 | 41 | S4, R1, A6, D4, D8 | Red |
| 102 | 41 | S4, R2, A6, D4, D8 | Yellow |
| 107 | 42 | S4, D6 | Yellow |
| 109 | 43 | S2, Z5 | Yellow |
| 110 | 44 | S2, Z4 | Red |
| 111 | 45 | S4, F3, T3, C3 | Yellow |
| 112 | 45 | S4, F3, T3 | Yellow |
| 113 | 46 | Z12 | Green |
| 114 | 47 | Z13 | Green |
| 115 | 48 | Z14 | Green |
| 116 | 49 | Z15 | Green |
| 117 | 50 | Z16 | Green |
| 118 | 51 | S4, Z10 | Green |
| 119 | 52 | S4, T1, Z9 | Red |
| 120 | 52 | S4, T2, Z9 | Yellow |
| 121 | 52 | S4, T3, Z9 | Green |
| 122 | 53 | S4, T7 | Yellow |
| 123 | 54 | S4, T5 | Red |
| 124 | 55 | S4, X3 | Red |
| 125 | 55 | S4, X2 | Yellow |
| 126 | 55 | S4, X1 | Yellow |
| 127 | 56 | S4, T4 | Yellow |
| 128 | 21 | S1, F2 | Yellow |
| 129 | 13 | S5, C1 | Red |
| 130 | 13 | S5, C2 | Yellow |
| 131 | 45 | S4, F4 | Green |
| 132 | 45 | S4, T3, C3 | Yellow |
| 133 | 45 | S4, F3, C3 | Yellow |
| 134 | 57 | S4, A7 | Red |
| 135 | 57 | S4, A13 | Yellow |
| 136 | 57 | S4, A12 | Green |

| | TABLE: | pstate |
|---|---|---|
| 1 | S1 | Solid, Crystal, Powder. |
| 2 | S2 | Liquids |
| 3 | S3 | Gas |
| 4 | S4 | Solids/Liquids/Unidentified |
| 5 | S5 | Cryogenic Gas/Aerosol |
| 7 | S6 | Cryogenic Solid |

| | | TABLE: | Haz_Validation | | | | | | |
|---|---|---|---|---|---|---|---|---|---|
| 1 | S1 | F1, F2, F3, | T1, T2, T3, | C1, C2, C3 | R1, R2 | A1, A2, A3, | D4, D5, D6, | X1, X2, X3 | Z6, Z8, Z9, |
| | | F4, F5 | T4, T5 | | | A4, A6, A7, | D7, D8, D9 | | Z10 |
| | | | | | | A8, A9, A10, | | | |
| | | | | | | A11, A12, | | | |
| | | | | | | A13, A14 | | | |
| 2 | S2 | FO, F1, F2, | T1, T2, T3, | C1, C2, C3 | R1, R2 | A1, A2, A3, | D1, D2, D3, | X1, X2, X3 | Z4, Z5, Z6, |
| | | F3, F4, F5 | T4, T5 | | | A4, A6, A7, | D4, D5, D6, | | Z9, Z10 |
| | | | | | | A8, A9, A10, | D7, D8, D9 | | |
| | | | | | | A11, A12, | | | |
| | | | | | | A13, A14 | | | |
| 3 | S3 | F1, F2 | NULL | C1, C2 | NULL | NULL | NULL | NULL | Z5 |
| 4 | S4 | F1, F2, F3, | T1, T2, T3, | C1, C2, C3 | R1, R2 | A1, A2, A3, | D4, D5, D6, | X1, X2, X3 | Z6, Z9, Z10 |
| | | F4, F5 | T4, T5 | | | A4, A6, A7, | D7, D8, D9 | | |
| | | | | | | A8, A9, A10, | | | |
| | | | | | | A11, A12, | | | |
| | | | | | | A13, A14 | | | |
| 5 | S5 | F0, F1, F2, | T1, T2, T3, | C1, C2 | NULL | A2, A6 | NULL | NULL | NULL |
| | | F4, F5 | T7 | | | | | | |

Representative hazard classification categories may include, for example, the following:

1. Gases—Highly Flammable (Compressed, Liquefied or Cryogenic)

2. Gases—Flammable and/or Toxic (Compressed, Liquefied or Cryogenic)

3. Gases—Combustible, Corrosive and Slightly Toxic (Compressed, Liquefied or Cryogenic)

4. Gases—Toxic and/or Corrosive (Compressed, Liquefied or Cryogenic)

5. Gases—Non-Reactive Asphyxiants (Compressed, Liquefied or Cryogenic)

6. Carbon Dioxide (Compressed, Liquefied or Cryogenic)

7. Gases-Oxidizing (Compressed, Liquefied or Cryogenic)

8. Oxygen (Compressed, Liquefied or Cryogenic)

9. Gases—Toxic, Corrosive and Oxidizing (Compressed, Liquefied or Cryogenic)

10. Gases—Toxic, Spontaneously Combustible (Pyrophoric) (Compressed or Liquefied)

11. Gases-Flammable, Unstable

12. Gases—Flammable, Corrosive

13. Gases—Corrosive

14. Liquids—Highly Flammable

15. Liquids—Flammable

16. Liquids—Highly Flammable, Toxic

17. Liquids—Flammable, Toxic

18. Liquids—Highly Flammable, Toxic and/or Corrosive

19. Liquids—Flammable, Toxic and/or Corrosive

20. Liquids—Flammable, Corrosive

21. Solids—Flammable

22. Solids—Flammable, Toxic and/or Corrosive

23. Substances—Self-Reactive

24. Substances—Self-Reactive, Temperature-Controlled

25. Substances—Spontaneously Combustible (Air-Reactive)

26. Substances—Spontaneously Combustible (Air and/or Water Reactive)

27. Substances—Water-Reactive (Evolving Flammable Gas)

28. Substances—Water-Reactive (Evolving Flammable and Toxic Gases)

29. Substances—Water-Reactive, Oxidizers (Evolving Toxic and/or Corrosive Gases)

30. Substances—Toxic

31. Substances—Toxic and Corrosive

32. Substances—Combustible, Toxic and/or Corrosive

33. Substances—Toxic and/or Corrosive (Non-combustible)

34. Substances—Flammable, Toxic and/or Corrosive (Water-Reactive)

35. Substances—Combustible, Toxic and/or Corrosive (Water-Reactive)

36. Substances—Non-combustible, Corrosive and/or Toxic (Water-Reactive)

37. Substances—Water-Reactive and Corrosive

38. Phosphorus, White/Yellow

39. Oxidizers

40. Oxidizers-Toxic

41. Organic Peroxides

42. Substances—Irritating

43. Halogenated Solvents

44. Mercury

45. Low-to-Moderate Hazard Substances

46. Mercury Thermometers

47. Alloys

48. Electrical Bulbs

49. Electrodes

50. Batteries

51. Articles

52. Pharmaceutical Drugs

53. Hazardous Drugs

54. Cytotoxic Drugs

55. Radioactive Substances

56. Biohazardous Substances

57. Explosives

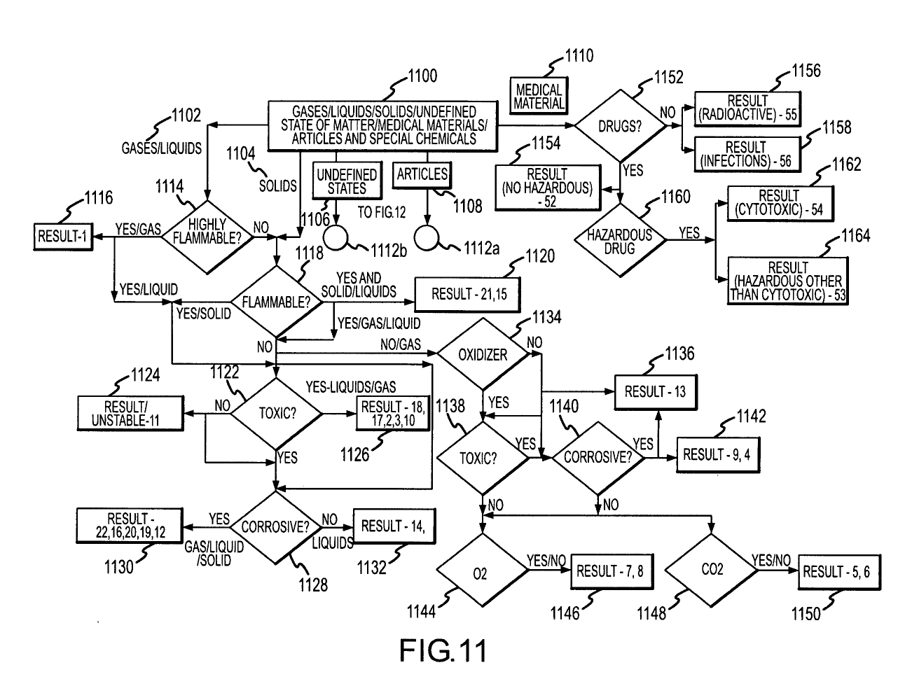

With reference to FIG. 11, classification workflow may begin 1100 with the user specification of the physical state of matter. If the physical state corresponds to gases or liquids 1102, workflow may be configured to obtain flammability data 114. If the material is a gas and is highly flammable, classification code ‘1’ may be returned 1116. If the material is a liquid and is highly flammable, workflow processing may be configured to obtain toxicity data 1122. If the material was not highly flammable 1114, workflow may be routed to determine whether the material is nominally flammable 1118. Similarly, if the physical state of matter 1100 corresponds to a solid 1104, workflow may be configured to obtain nominal flammability data 1118.

If a solid or liquid material is determined to demonstrate nominal flammability, classification codes ‘21’ or ‘15’ may result 1120. Alternatively, if the material is not nominally flammable 1118 and is a gas, workflow processing may be passed for a determination of whether the material is an oxidizer 1134. If not, then a classification code of ‘13’ may result 1136. If the material is determined to demonstrate characteristics of an oxidizer, then a subsequent toxicity determination 1138 may be made. If the oxidizer material 1134 is not toxic 1138, then the classification code of ‘7’ or ‘8’ may result 1146 for oxygen 1144, for example. If, on the other hand, the oxidizer material is toxic 1138, then a subsequent determination of corrosivity 1140 may result. If the material is also corrosive, then classification codes ‘13’, ‘9’ or ‘4’ may result (1136, 1142). In the case where multiple classification codes may result, further processing and validation of the results of peripheral processing will permit the material to generally be assigned a unitary classification code. The procedure of validation may use any raw data entered by the user, any processed data resulting from classification workflow, and/or any post-processed data in any combination for determining a unitary classification code. If the oxidizer material 1134 is not corrosive 1140, then a classification code of ‘5’, ‘6’, ‘7’ or ‘8’ may result (1146, 1150) corresponding, for example, to oxygen 1144 or carbon dioxide 1148.

If the material is not nominally flammable 1118 or is nominally flammable and a solid, workflow processing may be configured to pass to a determination of toxicity 1122. If the material is not toxic 1122, it may be assigned classification code ‘11’ 1124 or workflow processing may continue with a determination of corrosivity 1128. If the material is toxic 1122 and appears in the liquid or gas phase, a classification code of ‘18’, ‘17’, ‘2’, ‘3’ or ‘10’ may result 1126. If the material is corrosive 1128, then the classification code of ‘22’, ‘16’, ‘20’, ‘19’, or ‘12’ may result 1130. If the material is not corrosive 1128, then the classification code of ‘14’ may result 1132.

If the material is determined to correspond to a material adapted for medical use 1110, workflow processing may be configured to pass to a determination of whether the material is a drug 1152. If the material is a drug 1152 but not hazardous, then classification code ‘52’ may result 1154. Alternatively, if the material is a drug 1152 and is hazardous 1160 and is cytotoxic, then classification code ‘54’ may result 1162. If the material is a drug 1152 and is hazardous 1160 and is not cytotoxic, then classification code ‘53’ may result 1164. If the medical material 1110 is not a drug 1152 and is radioactive, then classification code ‘55’ may result 1156. If the medical material 1110 is not a drug 1152 and demonstrates a tendency to produce infections, then classification code ‘56’ may result 1158.

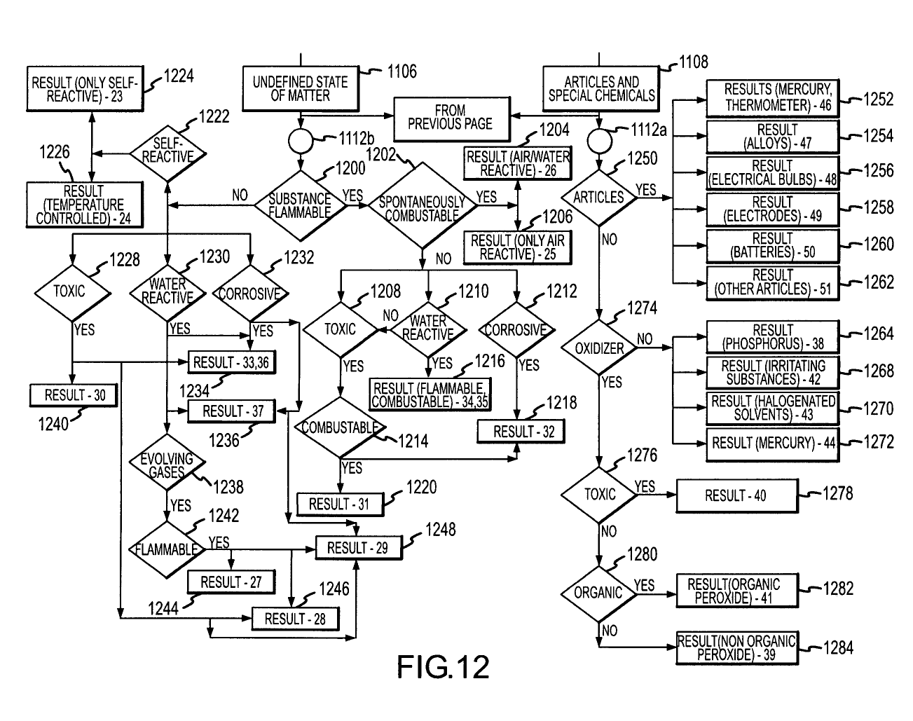

If the material appears in an undefined state 1106 or corresponds to an article 1108, workflow passes to the diagram generally depicted in FIG. 12 (1112b and 1112a, respectively). If the material has an undefined state 1106, a determination of flammability 1200 may be made. If the material 1106 is not flammable 1200, then a determination of self-reactivity 1222, water reactivity 1230, toxicity 1228 and/or corrosivity 1232 may result. In accordance with various representative and exemplary embodiments of the present invention, various portions of the workflow diagram generally describe and depicted in FIGS. 11 and 12 may be adapted for substantially parallel processing.

If the material corresponding to an undefined state 1106 is not flammable 1200 and is self-reactive 1222, the resulting classification code may correspond to ‘24’ or ‘23’ depending on whether the self-reactivity is temperature controlled or not, respectively. If the material 1106 is not flammable 1200 and is toxic 1228, the classification code of ‘30’ may result 1240. If the material 1106 is not flammable 1200 and is toxic 1228 and is corrosive 1232, the classification code of ‘33’ or ‘36’ may result 1234. If the material 1106 is not flammable 1200 and is water reactive 1230, the classification code of ‘33’, ‘36’ or ‘37’ may result. If this same material also demonstrates the evolution of gases from reaction 1238, which are themselves flammable 1242, the classification codes of ‘29’, ‘27’ and ‘28’ may result (1244, 1246, 1248). If the material 1106 is not flammable 1200 and is corrosive 1232, then the classification code of ‘33’, ‘36’ or ‘37’ may result (1234, 1236).

If the material corresponds to an article 1108, then the following classification assignments may be possible: ‘46’ mercury, thermometer 1252; ‘47’ alloys 1254; ‘48’ electrical bulbs' 1256; ‘49’ electrodes 1258; ‘50’ batteries 1260; ‘51’ other articles 1262; etc. If the material 1108 is not an article 1250 and is not an oxidizer 1274, then the following classification assignments may be possible: ‘38’ phosphorus 1264; ‘42’ irritating substance 1268; ‘43’ halogenated solvents 1270; ‘44’ mercury 1272; etc.

If the material 1108 is not an article 1250 and is an oxidizer 1274 and is toxic, then classification code ‘40’ may result 1278. If the material 1108 is not an article 1250 and is an oxidizer 1274 and is not toxic, but is organic, then classification code ‘41’ may result 1282, corresponding for example to an organic peroxide. If the material 1108 is not an article 1250 and is an oxidizer 1274 and is not toxic and is not organic, then classification code ‘39’ may result 1282, corresponding for example to sa non-organic peroxide.

Application of the disclosed system and method for the determination, classification and communication of chemical hazards may be applied to produce, for example, a hazard summary sheet such as generally depicted, for example, in FIG. 13. Hazard information 1300 may comprise, for example, a hazard level indicator and/or icon 1307 in addition to a classification code and/or category index 1305. The summary sheet may also be configured to provide more detailed information 1310 concerning specific risks or special considerations.

It will be appreciated that the software elements of the present invention may be implemented with any programming or scripting language such as, for example, C, C++, Java, COBOL, assembler, PERL, extensible Markup Language (XML), etc., or any programming or scripting language now known or hereafter derived in the art, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography, please review a text written by Bruce Schneider entitled “Applied Cryptography: Protocols, Algorithms, And Source Code In C,” published by John Wiley & Sons (second edition, 1996), which is hereby incorporated by reference.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

It will be appreciated, that many applications of the present invention could be formulated and that a network may be provided that may include any system for exchanging data, such as, for example, the Internet, an intranet, an extranet, WAN, LAN, satellite communications, and/or the like. It may be noted that the network can be implemented as other types of networks, such as an interactive television (ITV) network. The users may interact with the system via any input device such as a keyboard, mouse, kiosk, personal digital assistant, handheld computer (i.e., Palm Pilot®), cellular phone and/or the like. Similarly, the invention could be used in conjunction with any type of personal computer, network computer, workstation, minicomputer, mainframe, or the like running any operating system such as any version of Windows, Windows XP, Windows Whistler, Windows ME, Windows NT, Windows2000, Windows 98, Windows 95, MacOS, OS/2, BeOS, Linux, UNIX, or any operating system now known or hereafter derived by those skilled in the art. Moreover, the invention may be readily implemented with TCP/IP communications protocols, IPX, AppleTalk, IP-6, NetBIOS, OSI or any number of existing or future protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the internet. In this context, the computers may or may not be connected to the internet at all times. Specific information related to data traffic protocols, standards, and application software utilized in connection with the Internet may be obtained, for example, from DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference. A variety of conventional communications media and protocols may be used for data links, such as, for example, a connection to an Internet Service Provider (ISP) over the local loop as is typically used in connection with standard modem communication, cable modem, Dish networks, ISDN, Digital Subscriber Line (DSL), or various wireless communication methods. Polymorph code systems might also reside within a local area network (LAN) which interfaces to a network via a leased line (T1, T3, etc.). Such communication methods are well known in the art, and are covered in a variety of standard texts. See, i.e., GILBERT HELD, UNDERSTANDING DATA COMMUNICATIONS (1996), hereby incorporated by reference.

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Data communication may be accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. It will be further appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific exemplary embodiments; however, it will be appreciated that various modifications and changes may be made without departing from the scope of the present invention as set forth in the claims below. The specification and Figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any device claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, material or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A system for at least partially classifying a material, said system comprising a computing device configured to:
store physical data for said material;
validate said physical data; and
process at least one of said validation data and said physical data to produce a classification value.

2. The system of claim 1, wherein said physical data comprises at least one of chemical/article data, radioactivity data, reactivity data, flammability data, corrosivity data, toxicity data, and state of matter data.

3. The system of claim 2, wherein said physical data further comprises at least one of combustibility data, compressibility data, oxidation data, hydrophilicity data, and hydrophobicity data.

4. The system of claim 2, wherein said physical data further comprises at least one of chemical functionality data, functional group data, moiety data, elemental composition data, molecular/atomic weight data, and electronegativity data.

5. The system of claim 1, further comprising at least one of icons, symbols and bar codes to at least one of index, access and identify stored data.

6. The system of claim 1, wherein classification information is communicated in a format in substantial agreement with a regulatory standard.

7. The system of claim 6, wherein said regulatory standard is at least one of an OSHA regulation, a United States Federal regulation, and an International regulation.

8. The system of claim 7, wherein said International regulation further comprises a standard in substantial agreement with the Global Harmonization of Hazard Communication.

9. The system of claim 1, further comprising at least one of a bar code scanner, a smartcard and an ID device.

10. A method for at least partially classifying a material, said method comprising the steps of:
providing at least one of state of matter data, toxicity data, corrosivity data,
flammability data, reactivity data, and radioactivity data for said material;
optionally providing at least one of characteristic data and chemical/article designation data for said material;
optionally validating at least two of said chemical/article data, characteristic data, radioactivity data, reactivity data, flammability data, corrosivity data, toxicity data, and state of matter data with respect to each other; and
processing at least one of said chemical/article data, characteristic data, radioactivity data, reactivity data, flammability data, corrosivity data, toxicity data, state of matter data, and validation data to produce a classification value.

11. The method of claim 10, further comprising the step of providing a material hazard summary sheet comprising at least one of classification data, chemical/article data, characteristic data, radioactivity data, reactivity data, flammability data, corrosivity data, toxicity data, and state of matter data.

12. The method of claim 10, further comprising the step of providing a material hazard summary sheet comprising at least one of combustibility data, compressibility data, oxidation data, hydrophilicity data, and hydrophobicity data.

13. The method of claim 10, further comprising the step of providing a material hazard summary sheet comprising at least one of chemical functionality data, functional group data, moiety data, elemental composition data, molecular/atomic weight data, and electronegativity data.

14. The method of claim 10, further comprising the steps of:
providing at least one of an icon, a symbol and a bar code; and
at least one of indexing, accessing and identifying data as a function of at least one of an icon, a symbol and a bar code.

15. The method of claim 10, further comprising the step of communicating a hazard classification in a format that is in substantial agreement with a regulatory standard.

16. The method of claim 15, wherein said regulatory standard is at least one of an OSHA regulation, a United States Federal regulation, and an International regulation.

17. The method of claim 16, wherein said International regulation further comprises a standard in substantial agreement with the Global Harmonization of Hazard Communication.

18. The method of claim 10, further comprising the step of providing at least one of a bar code scanner, a smartcard and an RF/ID device.

19. The method of claim 10, further comprising the step of classifying a plurality of materials.

20. The method of claim 19, further comprising the step of providing a plurality of material hazard summary sheets comprising at least one of classification data, chemical/article data, characteristic data, radioactivity data, reactivity data, flammability data, corrosivity data, toxicity data, and data of matter data.
